(19) United States
(12) Patent Application Publication
(10) Pub. No.: US 2010/0110090 A1
(43) Pub. Date: May 6, 2010

(54) ACTIVE-MATRIX DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/595,048

(22) PCT Filed: Apr. 2, 2008
(86) PCT No.: PCT/US08/04300

§ 371 Date: Oct. 8, 2009

(30) Foreign Application Priority Data
Apr. 13, 2007 (JP) 2007-106423U

(51) Int. Cl. G09G 5/36

(52) U.S. Cl. 345/547; 345/82

(57) ABSTRACT

Multiple grayscale image data is displayed efficiently. Image data is stored in a frame memory, and a predetermined bit of the image data is also stored in a pixel memory having a memory for each pixel. Video data in the pixel memory and video data in the frame memory (22) are exchanged using an input/output unit, to control display of an image in a pixel.

### FIELD OF THE INVENTION

The present invention relates to an active matrix display device having pixels arranged in a matrix form, and in particular, to an active matrix display device having a memory in each pixel.

### BACKGROUND OF THE INVENTION

Because a higher resolution is possible with active matrix display devices, active matrix display devices became widespread as displays. An active matrix display device requires an active element for determining a display state in each pixel. In particular, in a current-driven display such as an organic electroluminescence (hereinafter referred to as “EL”) display, a driving transistor is provided which can continue to supply a current to a light emitting element. As the driving transistor, a thin film transistor (“TFT”) is used which is formed by a thin film such as amorphous silicon and polysilicon. However, it is difficult to make the characteristics of the TFT uniform.

Several methods have been proposed as a method for correcting the characteristics of the TFTs with a circuit technology. One of these methods is a digital driving method, and there is known a method in which grayscale in an active matrix organic EL display is controlled though digital driving (WO 2005-116971).

A display device having such a digital input must generate a light emission intensity which is an analog output according to input digital data regardless of the form of the display device, and thus comprises a digital-to-analog conversion (DA conversion) unit.

Digital driving is a driving method in which the DA conversion is realized by changing a pulse width of the light emission period, and is realized using a plurality of sub frames and a pixel which can maintain written digital data for a certain period of time.

A pixel disclosed in the related art, however, comprises a storage capacitor, which provides a write-only dynamic memory function to maintain written data for a certain period of time, and generate a light emission intensity corresponding to the data with a pulse width. Because of this, a memory which can be read and written must be provided externally, and a refresh operation (an operation to periodically write data to the pixel at a certain interval) must be constantly applied in the pixel with the memory data.

When an external memory is required and the size of the image data is increased such as, for example, an increase in a number of pixels and a number of bits in data, the cost is also increased with the increase in the memory size.

### SUMMARY OF THE INVENTION

According to one aspect of the present invention, there is provided an active matrix display device comprising a pixel memory having a plurality of pixels arranged in a matrix form, each pixel having a memory of one bit which stores video data and realizing display based on the video data, and an external memory which stores video data, wherein display of video in a pixel is controlled by exchanging video data in the pixel memory and video data in the external memory.

According to another aspect of the present invention, it is preferable that, in the active matrix display device, a plurality of divided pixels each having a memory of one bit is provided in a pixel of the pixel memory, and display for digital data of a plurality of bits is realized using the plurality of divided pixels by controlling a light emission period using a sub frame for a portion of the divided pixels of the pixel.

According to another aspect of the present invention, it is preferable that, in the active matrix display device, the external memory has a memory capacity which is smaller than that for one screen.

According to another aspect of the present invention, it is preferable that, in the active matrix display device, the pixel comprises at least a pair of divided pixels having comparable light emission intensities.

According to another aspect of the present invention, it is preferable that, in the active matrix display device, the divided pixel comprises an organic electroluminescence element.

According to another aspect of the present invention, there is provided an active matrix display device in which a plurality of pixels are arranged in a matrix form and display in each pixel is realized according to video data, the active matrix display device comprising a frame memory which stores video data comprising a plurality of bits for each pixel, and a signal controller which reads video data for each pixel stored in the frame memory and supplies the video data to a corresponding pixel, wherein each pixel comprises a plurality of divided pixels having a static memory of at least one bit which stores a supplied video signal, and a light emitting element which emits light according to a video signal stored in the static memory, and the signal controller reads a video signal stored in the frame memory, supplies the read video signal to a corresponding pixel, and realizes a display for digital data of a plurality of bits using a plurality of divided pixel by controlling a light emission period of a portion of the divided pixels of the pixel using a sub frame.

As described, according to various aspects of the present invention, display can be realized by storing video data in a pixel memory and video data can be exchanged with the external memory. Thus, it is not necessary to store all video data in the external memory.

In addition, by dividing one pixel of a pixel memory into a plurality of divided pixels, display for video data of a plurality of bits can be realized using the divided pixels, and display with a reduced number of sub frames can be realized.

### BRIEF DESCRIPTION OF THE DRAWINGS

Preferred embodiments of the present invention will be described in detail by reference to the drawings, wherein:

FIG. 1 is a diagram showing an overall structure of a display device;

FIG. 2 is a timing chart for writing and reading of data in digital driving;

FIG. 3 is a diagram showing a data exchange table;

FIG. 4 is a diagram showing an address data exchange table;

FIG. 5 is a diagram showing a static memory pixel;

FIG. 6 is a diagram showing another static memory pixel;

FIG. 7A is a diagram showing a pixel comprising divided pixels;

FIG. 7B is a diagram showing another pixel comprising divided pixels;

FIG. 8 is a timing chart of writing and reading of data of another digital driving;

FIG. 9 is a diagram showing another data exchange table;

FIG. 10 is a diagram showing another address data exchange table; and

FIG. 11 is a diagram showing an example pixel which uses a capacitor for a memory.

### DETAILED DESCRIPTION OF THE PREFERRED EMBODIMENT

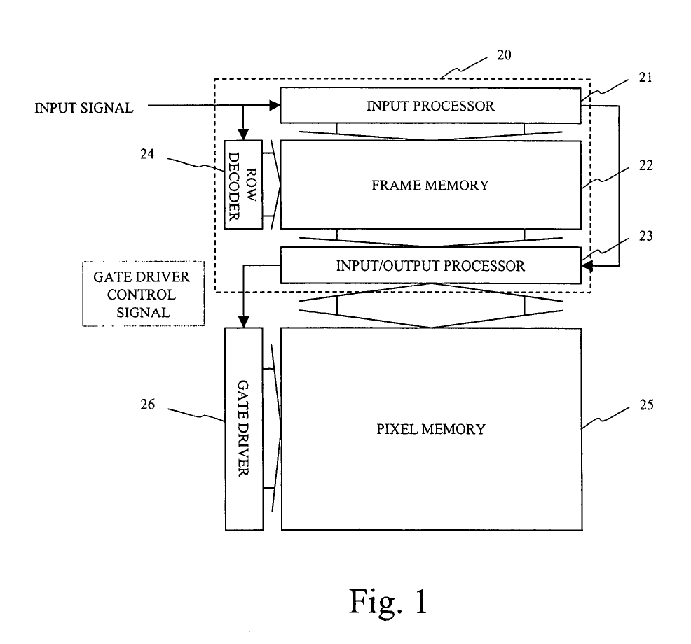

FIG. 1 shows an overall structure of a display device according to a preferred embodiment of the present invention comprising a pixel memory 25 in which pixels comprising a static memory are arranged in an array.

The display device of FIG. 1 comprises a data driver 20, a gate driver 26, and a pixel memory 25. The gate driver 26 and the pixel memory 25 may often be formed on the same substrate. The gate driver 26 may alternatively be formed as a separate integrated circuit (IC) or may be included in a data driver 20 which is provided as another IC. The data driver 20 may be formed on the same substrate as the pixel memory 25.

The data driver 20 comprises an input processor 21 which reads an input signal from outside, a frame memory 22 which is an external memory that can maintain at least one screen of input signals, a row decoder 24, and an input/output processor 23 which reads memory data of a line selected by the row decoder 24 from the frame memory 22, outputs the memory data to the pixel memory 25, reads memory data of a line selected by the gate driver 26 from the pixel memory 25, and writes the memory data to the frame memory 22.

By introducing the frame memory 22 into the data driver 20, when an image having no change of video, such as a still image, is displayed, the supply of an input signal from the outside can be omitted. In other words, by reading still image data which is once stored in the frame memory 22 and outputting the still image data to the pixel memory 25, it is possible to continue displaying the video data in the pixel memory 25.

Because the function to allow omission of supply of the input signal from the outside can reduce power consumption required for data transfer, such a function is preferable in applications which require low power consumption, such as a mobile terminal.

A specific signal processing method of digital driving using the data driver 20 may differ according to the number of bits of the static memory in one pixel of the pixel memory 25. As a simplest example, an example is considered in which a static memory of one bit is introduced to each pixel. In the case of a full-color display, similar processes can be applied to each of red (R), green (G), and blue (B).

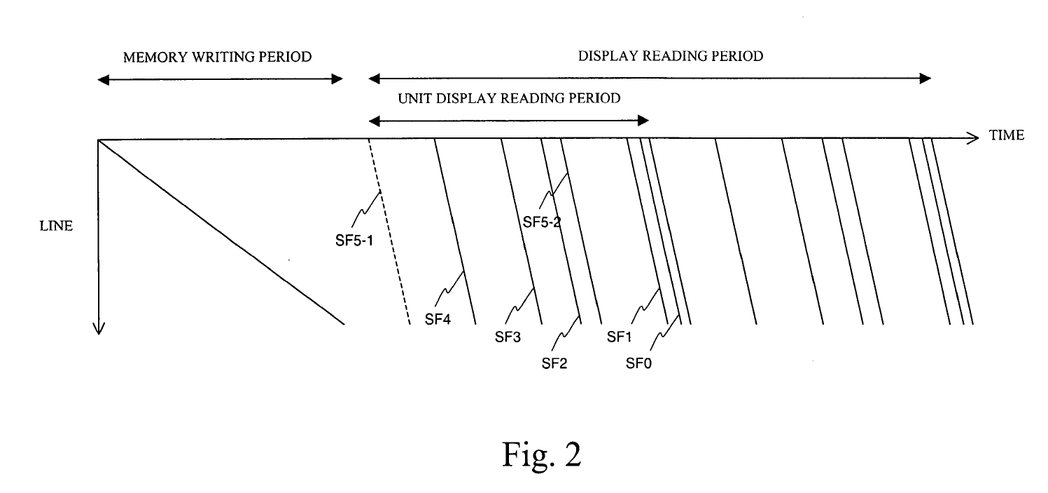

FIG. 2 shows an example configuration in which the pixel memory 25 is driven with digital driving of 6 bits, realized by a sub frame structure and timing with input data of 6 bits. According to FIG. 2, a plurality of pixels are simultaneously selected. This can be achieved by dividing a selection period of one line into a plurality of periods as described in WO 2005-116971

In the example configuration of FIG. 2, a sub frame SF5 of a fifth bit is divided into two including SF5-1 and SF5-2, and bit data is written in order of SF5-1, SF4, SF3, SF2, SF5-2, SF1, and SF0. The sub frames SF5 (SF5-2+SF5-1), SF4, SF3, SF2, SF5-2, SF1, and SF0 have periods of lengths of 32(16+16), 16, 8, 4, 2, and 1, respectively, when the length of the period of the sub frame SF0 is “1”.

Bit data of one bit can be stored in the pixel memory 25. Because of this, when the fifth bit which is the most significant bit (MSB) is to be stored in the pixel memory 25, the remaining bits from the fourth bit to the zeroth bit are stored in the frame memory 22.

This operation will now be described. When image data is input from the outside, first, the input processor 21 converts the video data which is input serially (in units of dots) into data in units of lines (line data). For example, data stored in a shift register for one line is transferred to a register of one line, and data of one line (in which each dot includes 6 bits) is obtained in the register. Of the converted line data, the line data of the fifth bit is output to the input/output processor 23 and the remaining data of 5 bits from the fourth bit to the zeroth bit is stored in a line of the frame memory 22 selected by the row decoder 24.

The input/output processor 23 outputs the line data of the fifth bit transmitted from the input processor 21 to the pixel memory 25 in units of lines, and outputs a control signal to the gate driver 26 to select the corresponding line.

The gate driver 26 includes, for example, a shift register, and may be of a sequential selection type in which the corresponding line is sequentially selected from the top or may be of a random selection type in which an address of the corresponding line is designated using a decoder or the like and is directly selected.

The process of writing to a memory such as the pixel memory 25 and the frame memory 22 is performed during a memory write period in FIG. 2. Because the input of the video data from the outside is transmitted at a timing generated at the outside, the memory writing timing depends on the external timing.

After the memory writing process is completed, the period transitions to a display read period. The read timing depends on a timing of digital driving processed by the data driver 20, with reading of all bit data being completed within a unit display read period (which is normally 60 Hz), and repeated for the display read period.

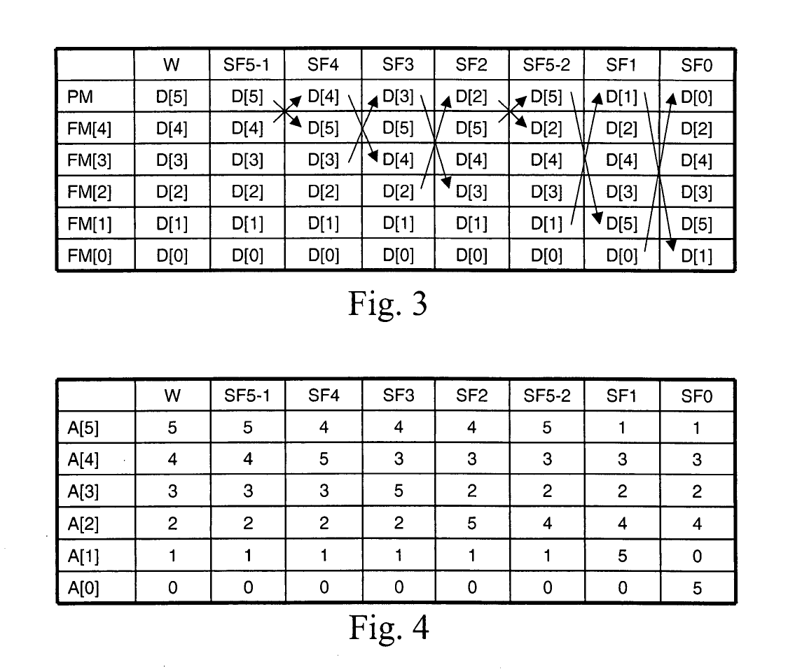

The reading order of the bit data is determined based on the order of sub frames shown in FIG. 2, and a memory bit is accessed as shown in FIG. 3.

Immediately after the memory writing (W) is completed, the pixel memory (PM) 25 stores the fifth bit data D[5] and the frame memory (FM) 22 stores the remaining bit data D[4]-D[0] in FM[4]-FM[0], respectively.

When display reading is started, reading is performed according to a digital driving procedure sequentially from the first line. Because the fifth bit data D[5] is already written to the pixel memory PM in the first sub frame SF5-1, there is no need for another process. However, when the sub frame SF4 is started, line data of the fourth bit data D[4] of the frame memory 22 is read to the input/output processor 23, and is temporarily moved.

When the line data of the fourth bit data D[4] is read, the memory data D[5] of the address PM of the same line of the pixel memory 25 is read and is stored in the fourth bit address FM[4] of the same line of the frame memory 22 through the input/output processor 23. Then, the fourth bit data D[4] which has been temporarily moved to the input/output processor 23 is written to the corresponding address of the pixel memory 25. This process is a process to exchange the fifth bit data of the pixel memory 25 with the fourth bit data of the frame memory 22. Neither of these data is lost, and both data are maintained. Alternatively, it is also possible to read the data of the pixel memory 25 first, move the read data to the input/output processor 23, then read the data of the frame memory 22, write the read data to the pixel memory 25, and write the moved data to the frame memory 22.

In the sub frame SF3, line data of the third bit data D[3] is read from the frame memory 22 to the input/output processor 23, the line data of the pixel memory data D[4] of the same line is stored in the third bit address of the same line of the frame memory 22 through the input/output processor 23, and the data exchange of the third bit data D[3] and the pixel memory data D[4] is completed.

In the sub frame SF2, data is exchanged in a similar manner, and in sub frame SF5-2, the line data of the fifth bit data D[5] of the frame memory 22 is again exchanged with the second bit data D[2] of the pixel memory 25.

As can be understood from FIG. 3, although the same fifth bit data is read in the sub frames SF5-1 and SF5-2, the addresses to be read differ from each other. Because the address in which the data is stored continuously changes according to the progress of the sub frame, it is convenient to constantly manage at which address the data to be read is stored using a table, such as the table of FIG. 4.

FIG. 4 shows a table which manages a history of exchange of addresses A[5]-A[0] corresponding to the data D[5]-D[0] with the elapse of the sub frames, in which an address of PM is assigned to “5”, an address of FM[4] is assigned to “4”, an address of FM[3] is assigned to “3”, an address of FM[2] is assigned to “2”, an address of FM[1] is assigned to “1”, and an address of FM[0] is assigned to “0”.

During memory writing (W), the address data stored in the addresses A[5]-A[0] are reset and initialized with the address data of “5”-“0”. This initialization can be performed so that the correspondence of the stored data with the memory of FIG. 3 matches.

For example, in the history of the address A[5] of the fifth bit data D[5], during the memory writing, address data “5” (PM) is set, and when the sub frame SF4 is completed, the address is updated with the address data “4” (FM[4]). This corresponds to the data exchange at the completion of the sub frame SF4 in FIG. 3. The fifth bit data D[5] matches the history stored in FM[4].

At the completion of the sub frame SF5-2, the address A[5] is updated with the address data “5” (PM), and at the completion of the subsequent sub frame SF1, the address is updated with the address data “1” (FM[1]) for data exchange with the first bit data D[1].

In this manner, by managing transition of addresses in relation to the bit data, the identification of at which address the necessary data is stored can be facilitated, which is convenient for control.

For example, when the sub frame SF5-2 is to be started, the fifth bit data D[5] must be read from the memory. For this purpose, first, it is necessary to determine an address at which the fifth bit data D[5] is stored. According to the address management table of FIG. 4, at the start of the sub frame SF5-2, the address data “4” is stored in reference to the address A[5], and thus it is possible to easily identify that the data is stored in FM[4].

Therefore, by appropriately updating the address management table of FIG. 4, the addresses corresponding to all bit data can be instantaneously identified, and address conversion due to the bit data exchange can be easily realized.

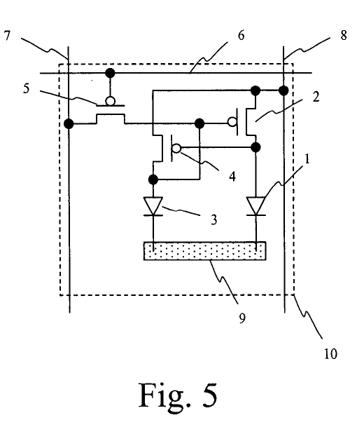

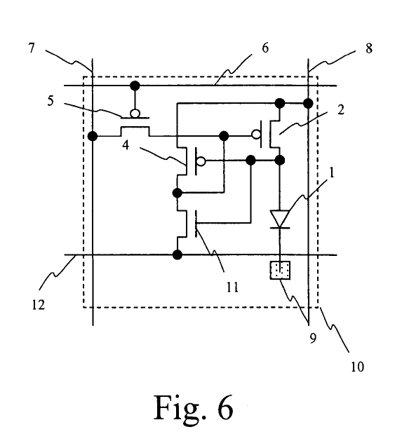

FIGS. 5 and 6 show example configurations of a pixel circuit in which a static memory is introduced. A pixel 10 shown in FIG. 5 comprises a first organic electroluminescence (hereinafter referred to as “EL”) element 1 which contributes to light emission, a first driving transistor 2 which drives the first organic EL element 1, a second organic EL element 3 which does not contribute to light emission, a second driving transistor 4 which drives the second organic EL element 3, and a gate transistor 5 which controls supply of a data voltage supplied on a data line 7 to a gate terminal of the first driving transistor 2 by a gate line 6 on which a selection signal is supplied.

An anode of the first organic EL element is connected to a drain terminal of the first driving transistor 2 and to a gate terminal of the second driving transistor 4, a gate terminal of the first driving transistor 2 is connected to an anode of the second organic EL element 3, to a drain terminal of the second driving transistor 4, and to a source terminal of the gate transistor 5, a gate terminal of the gate transistor 5 is connected to the gate line 6, and a drain terminal of the gate transistor 5 is connected to the data line 7. Source terminals of the first driving transistor 2 and the second driving transistor 4 are connected to a power supply line 8 and cathodes of the first organic EL element 1 and of the second organic EL element 3 are connected to a cathode electrode 9, and the pixel 10 is thus constructed.

The pixel and the static memory in FIG. 5 are made solely of PMOS transistors, and thus it is possible to manufacture these elements at low cost.

Use of a CMOS transistor as shown in FIG. 6 is preferable when a low power consumption is required even though the cost is relatively high. In a pixel 10 of FIG. 10, an NMOS transistor 11 is used in place of the second organic EL element 3. A drain terminal of the NMOS transistor 11 is connected to a drain terminal of the second driving transistor 4, to a gate terminal of the first driving transistor 2, and to a source terminal of the gate transistor 5. A source terminal of the NMOS transistor 11 is connected to a power supply line 12. The power supply lines 8 and 12 are supplied with different potentials, and a high potential is supplied to the power supply line 8 and a low potential is supplied to the power supply line 12. Alternatively, the power supply line 12 may also be constructed common with the cathode electrode 9.

The NMOS transistor 11 forms a CMOS inverter circuit with the second driving transistor 4. Thus, when one of the NMOS transistor 11 and the second driving transistor 4 is switched ON, the other transistor is switched OFF. Because of this, it is possible to maintain memory data without supplying a current.

More specifically, when high data is maintained on the gate terminal of the first driving transistor 2, because the first driving transistor 2 is switched OFF, potentials on the gate terminal of the second driving transistor 4 and on the gate terminal of the NMOS transistor 11 are lowered to a Low potential of the cathode electrode potential through the first organic EL element 1, the second driving transistor 4 is switched ON, the NMOS transistor 11 is switched OFF, and current from the power supply line 8 to the power supply line 12 is blocked. During this period, a High potential of the power supply line 8 is supplied to the drain terminal of the second driving transistor 4 connected to the gate terminal of the first driving transistor 2. Because of this, the High data can be maintained without consuming a current.

In a pixel having only the PMOS transistor as shown in FIG. 5, on the other hand, when High data is to be maintained at the gate terminal of the first driving transistor 2, the second driving transistor 4 is switched ON and a current flows through the second organic EL element 3. Although this current is a current required for generating the High voltage on the gate terminal of the first driving transistor 2, because power is consumed for maintaining the data, the power consumption cannot be reduced beyond a certain degree.

Because the light emission state of the first organic EL element 1 determines the light emission state of the pixel, it is necessary to ensure that the light emission from the second organic EL element 3 is not emitted to the outside. In other words, it is necessary to block the light by a metal or a black matrix or to form an organic EL element which does not emit light.

In order to read and write data using a pixel including the static memory as shown in FIGS. 5 and 6, it is possible to employ the following procedure.

During the data writing, a selection voltage for selecting a gate line 6, here a Low voltage, is set such that the ON resistance of the gate transistor 5 is less than the ON resistance of the second driving transistor 4 and the second organic EL element 3 or of the NMOS transistor 11. This is because a potential of data maintained at High or Low is maintained by being connected to a power supply line 8 or 12 or to the cathode electrode 9 through the ON resistance of the second driving transistor 4 or the second organic EL element 3 or NMOS transistor 11 and a potential of the data to be written is also determined by the divided voltages by both resistances as a potential of the data to be written is also supplied through the ON resistance of the gate transistor 5.

More specifically, when High data is maintained on the gate terminal of the first driving transistor 2 and Low data is to be written to the gate terminal to invert the data, although the High data is pulled up by the ON resistance of the second driving transistor 4, the potential of the High data is divided by the ON resistance of the gate transistor 5. When the ON resistance of the gate transistor is sufficiently low, the gate potential of the first driving transistor 2 moves to the side of the potential of the data line 7, and thus the first driving transistor 1 can be suitably switched to the ON state.

In the reading process, the configuration is reversed, and the ON resistance of the gate transistor 5 must be higher than the second driving transistor 4, the second organic EL element 3, and the NMOS transistor 11.

During the reading, the data line 7 is set at a floating state. However, regardless of the kind of data supplied to the data line 7 when the data line 7 is set to the floating state, when the ON resistance of the gate transistor 5 satisfies the above-described condition, it is ensured that the gate potential of the first driving transistor 2 is not rewritten due to the principle of the resistive divided voltage.

In order to more effectively read using the pixel of FIG. 5, it is desirable to pre-charge the data line 7 with the Low voltage prior to the reading and set the data line 7 at the floating state. During the reading, if the Low data is maintained at the gate terminal of the first driving transistor 2, the data line 7 does not change, but if High data is maintained, a current flows from the power supply line 8 through the ON resistance of the second driving transistor 4 and through the ON resistance of the gate transistor 5 to the data line 7. The pre-charged Low potential changes to the High potential while the gate potential of the first driving transistor 2 is maintained at High. This potential is preferably read by the input/output processor 23 of the data driver 20 and stored in the frame memory 22.

In other words, it is important to change the ON resistance of the gate transistor 5 at the reading and the writing, in order to control the pixel memory shown in FIGS. 5 and 6. In order to more easily change the ON resistance, it is preferable to set the selection voltage to be supplied to the gate line 6 at different potentials during the writing and the reading. This function can be easily realized by introducing a voltage switching switch in the gate driver 26.

In this manner, by using a pixel memory having a one bit static memory in each pixel shown in FIGS. 5 and 6 as a part of the frame memory, it is possible to set the capacity of the external memory in each pixel to 5 bits where the related art required 6 bits, and thus the cost of the display device can be reduced.

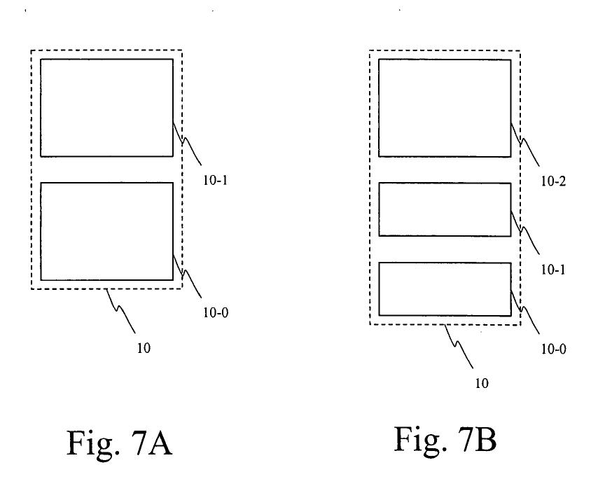

By dividing each of the plurality of pixels 10 arranged in a matrix into a plurality of pixels as shown in FIG. 7, and introducing a static memory into each divided pixel, it is possible to further reduce the capacity of the external frame memory.

FIG. 7A shows an example configuration in which two divided pixels including a divided pixel 10-1 and a divided pixel 10-0 having a static memory and comparable light emission intensity are introduced. FIG. 7B shows an example configuration in which three divided pixels including a divided pixel 10-1 and a divided pixel 10-0 having a static memory and comparable light emission intensity and a divided pixel 10-2 having a static memory and twice the light emission intensity. More specifically, assuming a grayscale generation of 6 bits, it is more preferable that a ratio between the divided pixel 10-1 and the divided pixel 10-0 is 32:31 in FIG. 7A and 16:15 in FIG. 7B.

The difference in the light emission intensity may be achieved by changing the amount of current by changing a light emission area or by applying different voltages.

In the case of FIG. 7B, because a ratio of the light emission intensity between the divided pixels 10-2 and 10-1 is 2:1, a DA conversion of 2 bits is realized in the divided pixels 10-2 and 10-1, and a grayscale of two bits can be generated. In the case of FIG. 7A, a DA conversion of one bit is achieved at the divided pixel 10-1, and a grayscale of one bit can be generated. When there is no divided pixel, the DA conversion must be realized by changing all light emission periods. With the introduction of the divided pixel, it is possible to employ a combination in which a part of the DA conversion is realized at divided pixels of different light emission intensities and remaining part of the DA conversion is supplemented by changing the light emission period.

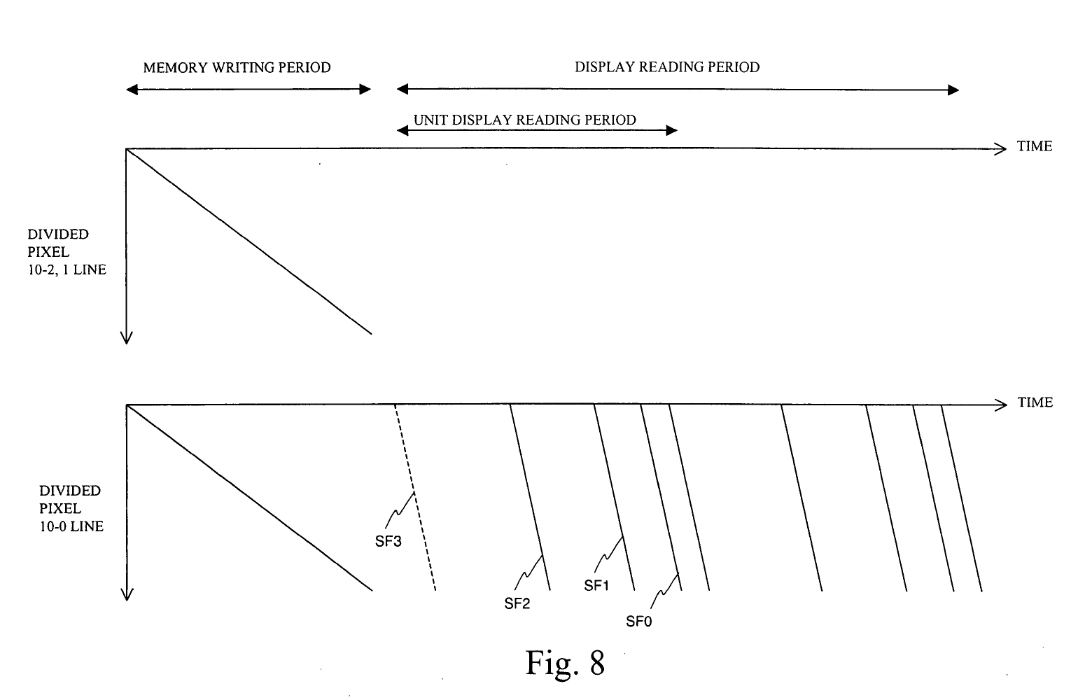

FIG. 8 shows an access timing chart for generating a grayscale of 6 bits using a divided pixel memory of FIG. 7B as an example of the combination of the DA conversion. When data of 6 bits is input from the outside, during a memory writing period, fifth bit data D[5] and fourth bit data D[4] of the 6-bit data are written to the divided pixels 10-2 and 10-1, respectively, third bit data D[3] is written to the divided pixel 10-0, and the three remaining bits, that is, bit data D[2]-D[0] are written to the external frame memory 22.

During the display reading period, a grayscale of 6 bits is generated. Because the divided pixels 10-2 and 10-1 are assigned dedicated to the fifth bit data and the fourth bit data, these divided pixels do not need to be read. In other words, in all periods of SF3-SF0, display by the fifth bit data D[5] and the fourth bit data D[4] is realized in the divided pixels 10-2 and 10-1.

The divided pixel 10-0 is used to generate the remaining grayscale of four bits using sub frames SF3-SF0. This is why the light emission intensity of the divided pixel 10-0 is desirably set at 15/63, and the 4-bit grayscale can be suitably realized with the divided pixel 10-0. In other words, in the divided pixel 10-0, by realizing the display by D[3] in SF3, by D[2] in SF2, by D[1] in SF1, and by D[0] in SF0, the display of periods of 8, 4, 2, and 1 is realized.

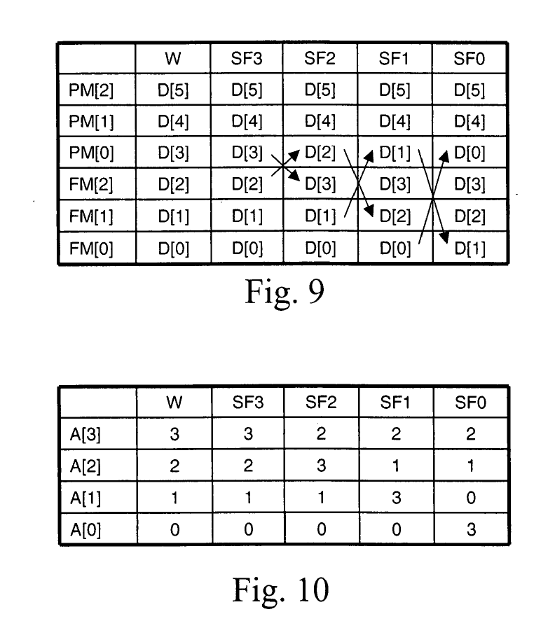

In the data exchange procedure, as shown in FIG. 9, the display of sub frame SF3 is started when the memory writing process is completed. Because the bit data D[3] is already written to the divided pixel 10-0, the same state is maintained. When the sub frame SF2 is started, the line data of the second bit data D[2] of the frame memory 22 is read from the address FM[2], and is temporarily moved by the input/output processor 23. Then, the third bit data D[3] for the same line is read from the pixel memory 25, and is written, through the input/output processor 23, to the address FM[2] at which the second bit data D[2] is stored. The second bit data D[2] temporarily moved to the input/output processor 23 is written to the pixel memory PM[0] of the same line. In other words, the third bit data D[3] of the pixel memory 25 and the second bit data D[2] of the frame memory 22 are exchanged.

When the sub frame SF1 is started, the first bit data D[1] of the frame memory 22 is read from the address FM[1] to the input/output processor 23, the second bit data D[2] of the same line of the pixel memory 25 is written to the address FM[1], and then, the first bit data D[1] is written to the pixel memory PM[0]. The sub frame SF0 proceeds in a similar manner, and the first bit data D[1] and the zeroth bit data D[0] are exchanged.

In this process also, it is convenient to suitably manage the addresses A[3]-A[0] corresponding to the bit data D[3]-D[0] associated with the exchange of the bit data. FIG. 10 shows an example configuration of such a process. An address of “5” is assigned to PM[2], an address of “4” is assigned to PM[1], an address of “3” is assigned to PM[0], an address of “2” is assigned to FM[2], an address of “1” is assigned to FM[1], and an address of “0” is assigned to FM[0]. The contents correspond to FIG. 9. Of the divided pixels, only the divided pixel 10-0 is applied to the sub frame display, and thus the sub frame can be 4 bits. Therefore, the address management is easier compared to the case in which there is no divided pixel.

When writing is started, the addresses A[3]-A[0] are initialized with “3”-“0”, respectively, and are maintained until the start of the sub frame SF2. When the sub frame SF2 is started, the second bit data is read and is stored in the pixel memory. At the completion of the sub frame SF2, the address A[2] is updated with “3” (PM[0]). On the other hand, the third bit data stored in the pixel memory is stored in the previous address “2” of the second bit data (FM[2]). Because of this, the address A[3] of the third bit data is updated with “2” (FM[2]). By updating the address due to the data exchange in a similar manner every time a sub frame is completed, it is possible to instantaneously find where the necessary data is stored in an arbitrary sub frame.

In this manner, by providing three divided pixels each including a static memory as shown in FIG. 7B, it is possible to reduce the capacity of the external memory by a factor of 2, namely, 3 bits.

When two divided pixels are introduced as shown in FIG. 7A, 4 bits are required for the external memory. The divided pixel 10-1 may be dedicated for the fifth bit data and the divided pixel 10-0 may be used to generate a grayscale of 5 bits using at least 5 sub frames.

More specifically, using sub frames SF4-SF0, it is possible to dedicate the divided pixel 10-1 to D[5], and set the divided pixel 10-0 to display D[4] in SF4, D[3] in SF3, D[2] in SF2, D[1] in SF1, and D[0] in SF0.

By introducing more divided pixels, it is possible to further reduce the external memory. However, as shown in FIG. 7, by providing at least a pair of the divided pixels 10-1 and 10-0 having a comparable light emission intensity, it is possible to increase a degree of freedom of the grayscale reproducing range.

For example, if the light emission intensity of the divided pixel 10-0 is set to be a half of that of the divided pixel 10-1 in FIG. 7, the grayscale reproducing range is limited to 2 bits in FIG. 7A and 3 bits in FIG. 7B, and thus is limited depending on the configuration of the divided pixels. This is also true when the number of divided pixels is increased to 6. That is, when a ratio among the light emission intensities of the divided pixels is set to 32:16:8:4:2:1, the grayscale reproducing range is limited by the hardware to 6 bits. When a larger number of grayscales is to be realized, such as 8 bits and 10 bits, the divided pixel configuration must use a method in which the control is complicated, such as the use of a pseudo-grayscale generating unit using resolution such as dithering and a random dither method, or application of a sub frame to a plurality of divided pixels to increase the number of grayscales in the divided pixels and the number of grayscales in the overall structure.

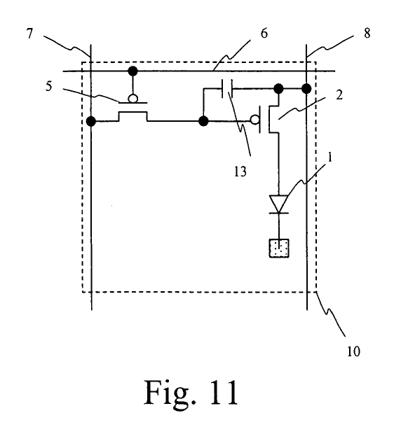

By adding a divided pixel such that the light emission intensity is 32:16:8:4:2:1:1, and supplementing the grayscale by applying sub frames to the last divided pixel, it is possible to easily realize a larger number of grayscales. The divided pixels do not need to be the same. For example, the pixel to be added may be a dynamic memory type pixel having a storage capacitor 13 between the gate terminal and the source terminal of the driving transistor 2 as shown in FIG. 11, in place of the static memory as shown in FIGS. 5 and 6. Alternatively, it is also possible to employ a configuration in which few bits are constructed using the pixel memory of FIG. 5 and the remaining bits are constructed using the pixel memory of FIG. 6.

### PARTS LIST

1 element

2 first driving transistor

3 element

4 second driving transistor

5 gate transistor

6 gate line

7 data line

8 power supply line

9 cathode electrode

10 pixel

11 nmos transistor

12 power supply line

13 storage capacitor

20 data driver

21 input processor

22 frame memory

23 input/output processor

24 row decoder

25 pixel memory

26 gate driver

1. An active matrix display device comprising:
a pixel memory having a plurality of pixels arranged in a matrix form, each pixel having a memory of one bit which stores video data and realizing display based on the video data; and
an external memory which stores video data, wherein
display of video in a pixel is controlled by exchanging video data in the pixel memory and video data in the external memory.

2. The active matrix display device according to claim 1, wherein:
a plurality of divided pixels each having a memory of one bit are provided in a pixel of the pixel memory; and
a display for digital data of a plurality of bits is realized using the plurality of divided pixels by controlling a light emission period using a sub frame for a portion of the divided pixels of the pixel.

3. The active matrix display device according to claim 1, wherein:
the external memory has a memory capacity which is smaller than that for one screen.

4. The active matrix display device according to claim 1, wherein:
the pixel comprises at least a pair of divided pixels having comparable light emission intensities.

5. The active matrix display device according to claim 1, wherein:
the divided pixel comprises an organic electroluminescence element.

6. An active matrix display device in which a plurality of pixels are arranged in a matrix form and display in each pixel is realized according to video data, the active matrix display device comprising:
a frame memory which stores video data comprising a plurality of bits for each pixel; and
a signal controller which reads video data for each pixel stored in the frame memory and supplies the video data to a corresponding pixel, wherein:
each pixel comprises a plurality of divided pixels having a static memory of at least one bit which stores a supplied video signal, and a light emitting element which emits light according to a video signal stored in the static memory; and
the signal controller reads a video signal stored in the frame memory, supplies the read video signal to a corresponding pixel, and realizes a display for digital data of a plurality of bits using a plurality of divided pixels by controlling a light emission period of a portion of the divided pixels of the pixel using a sub frame.
